(19) United States
(12) Patent Application Publication
(10) Pub. No.: US 2020/0076453 A1
(43) Pub. Date: Mar. 5, 2020

(54) RECEIVER

(71) Applicant: Mitsubishi Electric Corporation, Tokyo (JP)

(72) Inventors: Hiroto SAKAKI, Tokyo (JP); Nobuhiko ANDO, Tokyo (JP); Hiroshi OTSUKA, Tokyo (JP); Kenichi TAJIMA, Tokyo (JP)

(73) Assignee: Mitsubishi Electric Corporation, Tokyo (JP)

(21) Appl. No.: 16/615,286

(22) PCT Filed: Jun. 30, 2017
(86) PCT No.: PCT/JP2017/024155

§ 371 Date: Nov. 20, 2019

(51) Int. Cl. H04B 1/00; H04B 1/30

(52) U.S. Cl. CPC H04B 1/0057; H04B 2001/307; H04B 1/30

(57) ABSTRACT

A signal source (44) supplies local signals having different phases to a first mixer (42) and a second mixer (43). The first mixer (42) and the second mixer (43) perform frequency conversion on reception signals using the local signals. A first phase changing unit (51) and a second phase changing unit (52) receive output signals of the first mixer (42) and the second mixer (43) as input signals and generate in-phase and reversed phase signals of these signals. A first adder (53) adds output signals of the first phase changing unit (51) to separate multiple signals. A second adder (54) adds output signals of the second phase changing unit (52) to separate multiple signals.

### TECHNICAL FIELD

The present invention relates to a receiver for simultaneously receiving radio signals of a plurality of frequency bands.

### BACKGROUND ART

As the diversification of wireless communication progresses, receivers capable of receiving a plurality of radio signals (hereinafter referred to as “multi-channel receivers”) are required to be capable of simultaneously receiving a plurality of radio signals. In conventional multi-channel receivers, a plurality of radio signals is simultaneously received by providing multiple local signals corresponding to, in terms of the number, multiple radio frequencies and synthesizing output signals of the local signals to be used as a local signal of a mixer (see, for example, Patent Literature 1).

### CITATION LIST

### Patent Literatures

Patent Literature 1: WO 2011/087016 A

### SUMMARY OF INVENTION

### Technical Problem

In the prior art as described in the above Patent Literature 1, however, there is disadvantage that the power consumption increases due to the fact that the same number of signal sources as the number of radio signals to be received are required and that frequency conversion is performed in order to avoid frequencies of signals after frequency conversion from overlapping with each other, thus resulting in higher sampling frequencies of the analog-to-digital converter.

The present invention has been devised in order to solve such disadvantage, and it is an object of the present invention to provide a receiver capable of simultaneously receiving a plurality of radio signals while minimizing the number of signal sources for mixers that are necessary for reception even in a case where the number of radio signals to be received increases and suppressing increase of the circuit size and increase in the power consumption.

### Solution to Problem

A receiver according to the present invention includes: a signal source for generating first to fourth local signals; a first mixer for performing frequency conversion on four radio signals having different frequencies using the first and second local signals; a second mixer for performing frequency conversion on the four radio signals having different frequencies using the third and fourth local signals; a first phase changing unit for receiving output signals of the first mixer and output signals of the second mixer as input signals and outputting signals obtained by changing phases of the input signals from first and second output terminals thereof; a second phase changing unit for receiving output signals of the first mixer and output signals of the second mixer as input signals and outputting signals obtained by changing phases of the input signals from first and second output terminals thereof; a first adder for adding the signals of the first and second output terminals of the first phase changing unit; and a second adder for adding the signals of the first and second output terminals of the second phase changing unit, in which the first local signal and the third local signal have a same frequency but are out of phase, the second local signal and the fourth local signal have a same frequency but are out of phase, and the first local signal and the second local signal have different frequencies.

### Advantageous Effects of Invention

A receiver according to the present invention provides local signals having different phases from a signal source to a first mixer and a second mixer to perform frequency conversion, generates in-phase and reversed phase relationship of signals by a first phase changing unit and a second phase changing unit, and adds the in-phase signals and the reversed phase signals. This makes it possible to minimize the number of signal sources that are necessary and to suppress increase of the circuit size and increase in the power consumption while simultaneous reception of a plurality of radio signals is enabled.

### BRIEF DESCRIPTION OF DRAWINGS

FIG. 1 is a configuration diagram of a receiver according to the present invention.

FIG. 2 is a configuration diagram illustrating a frequency converting unit and a signal separating unit in the receiver of the first embodiment of the present invention.

FIG. 3 is an explanatory diagram illustrating four radio signals in the receiver of the first embodiment of the present invention.

FIG. 4 is an explanatory diagram illustrating output signals of a first band pass filter in the receiver of the first embodiment of the present invention.

FIG. 5 is an explanatory diagram illustrating output signals of a first adder in the receiver of the first embodiment of the present invention.

FIG. 6 is an explanatory diagram illustrating output signals of a second adder in the receiver of the first embodiment of the present invention.

FIG. 7 is a configuration diagram illustrating a modification of a first phase changing unit and a second phase changing unit in the receiver of the first embodiment of the present invention.

FIG. 8 is an explanatory diagram illustrating input signals of a first AD converter in a receiver of a second embodiment of the present invention.

FIG. 9 is an explanatory diagram illustrating output signals of the first AD converter in the receiver of the second embodiment of the present invention.

### DESCRIPTION OF EMBODIMENTS

To describe the present invention further in detail, embodiments for carrying out the present invention will be described below with reference to the accompanying drawings.

### First Embodiment

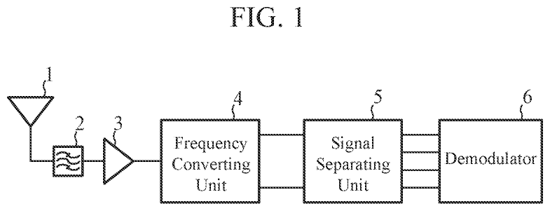

FIG. 1 is a configuration diagram of a receiver according to the present embodiment.

The receiver of the present embodiment includes an antenna 1, a filter 2, an amplifier 3, a frequency converting unit 4, a signal separating unit 5, and a demodulator 6 as illustrated. The antenna 1 receives a plurality of radio signals. The filter 2 is a band pass filter for removing unwanted signals from the radio signals received by the antenna 1. The amplifier 3 is an amplifier that amplifies the output signals from the filter 2 at a predetermined amplification factor. The frequency converting unit 4 is a processing unit that converts the frequency of the plurality of signals amplified by the amplifier 3. The signal separating unit 5 is a processing unit that performs signal separation on the signals frequency-converted by the frequency converting unit 4 and extracts individual signals. The demodulator 6 is a processing unit that demodulates the signals extracted by the signal separating unit 5.

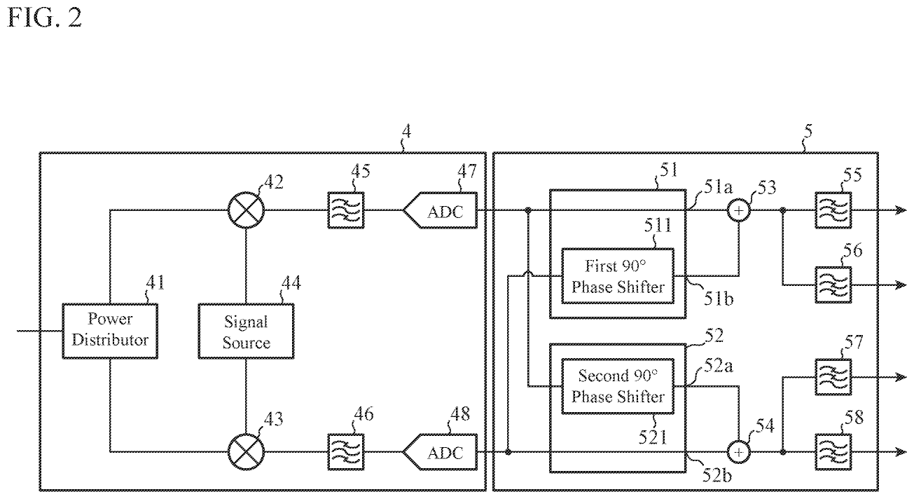

FIG. 2 is a configuration diagram illustrating details of the frequency converting unit 4 and the signal separating unit 5. The frequency converting unit 4 includes a power distributor 41, a first mixer 42, a second mixer 43, a signal source 44, a first band pass filter 45, a second band pass filter 46, a first analog-digital (AD) converter (ADC) 47, and a second analog-digital (AD) converter (ADC) 48.

The power distributor 41 is a circuit that divides the power of the output signals of the amplifier 3 into two and outputs the signals to each of the first mixer 42 and the second mixer 43. The signal source 44 is a processing unit that generates local signals for the first mixer 42 and the second mixer 43 and separately outputs the generated signals to the first mixer 42 and the second mixer 43. The first mixer 42 is a processing unit that performs frequency conversion on the signals output from the power distributor 41 using local signals output from the signal source 44, and outputs the frequency-converted signals to the first band pass filter 45. The second mixer 43 is a processing unit that performs frequency conversion on the signals output from the power distributor 41 using local signals output from the signal source 44, and outputs the frequency-converted signals to the second band pass filter 46.

The first band pass filter 45 passes only specific signals out of the output signals of the first mixer 42 and outputs the signals to the first AD converter 47. The second band pass filter 46 passes only specific signals out of the output signals of the second mixer 43 and outputs the signals to the second AD converter 48. The first AD converter 47 is a processing unit that converts the output signals of the first band pass filter 45 from the analog signals to digital signals, and outputs the converted signals to a first phase changing unit 51 in the signal separating unit 5. The second AD converter 48 is a processing unit that converts the output signals of the second band pass filter 46 from the analog signals to digital signals and outputs the converted signals to a second phase changing unit 52.

The signal separating unit 5 includes the first phase changing unit 51, the second phase changing unit 52, a first adder 53, a second adder 54, a first low pass filter 55, a first high pass filter 56, a second low pass filter 57, and a second high pass filter 58. The first phase changing unit 51 is a circuit that receives the output signals of the first AD converter 47 and the output signals of the second AD converter 48 as input signals and outputs signals obtained by changing the phase of these input signals. The first phase changing unit 51 has a first output terminal 51a and a second output terminal 51b for outputting these signals. The second phase changing unit 52 is a circuit that receives the output signals of the first AD converter 47 and the output signals of the second AD converter 48 as input signals and outputs signals obtained by changing the phase of these input signals. The second phase changing unit 52 has a first output terminal 52a and a second output terminal 52b for outputting these signals. The first phase changing unit 51 includes a first 90° phase shifter 511. The output signals of the second AD converter 48 are given as input signals to the first 90° phase shifter 511, and output signals of the first 90° phase shifter 511 are given to the second output terminal 51b. Meanwhile, the output signals of the first AD converter 47 are output as they are to the first output terminal 51a of the first phase changing unit 51. The second phase changing unit 52 includes a second 90° phase shifter 521. The output signals of the first AD converter 47 are given as input signals to the second 90° phase shifter 521, and output signals of the second 90° phase shifter 521 are given to the first output terminal 52a. Meanwhile, the output signals of the second AD converter 48 are output as they are to the second output terminal 52b of the second phase changing unit 52. The first 90° phase shifter 511 and the second 90° phase shifter 521 are circuits that delay the phase of an input signal by 90° and output the signal.

The first adder 53 is an operation unit that adds the signals output from the first output terminal 51a of the first phase changing unit 51 and the signals output from the second output terminal 51b. The second adder 54 is an operation unit that adds the signals output from the first output terminal 52a of the second phase changing unit 52 and the signals output from the second output terminal 52b. The first low pass filter 55 passes a signal having a low frequency out of the signals output from the first adder 53 and outputs the signal to the demodulator 6. The first high pass filter 56 passes a signal having a high frequency out of the signals output from the first adder 53 and outputs the signal to the demodulator 6. The second low pass filter 57 passes a signal having a low frequency out of the signals output from the second adder 54 and outputs the signal to the demodulator 6. The second high pass filter 58 passes a signal having a high frequency out of the signals output from the second adder 54 and outputs the signal to the demodulator 6. The outputs of the first low pass filter 55 through to the second high pass filter 58 are separately input to the demodulator 6.

Next, the operation of the receiver according to the first embodiment will be described. As an example, a case where four radio signals (denoted as signal S_{A}, signal S_{B}, signal S_{C}, and signal S_{D}) are received will be explained. The received radio signals are each expressed as the following using amplitudes A, B, C, and D of the signals S_{A} to S_{D}, time t, frequencies f_{LO1}, f_{LO2}, Δf₁, and Δf₂, and phases φ_{A}, φ_{B}, φ_{C}, and φ_{D}.

S_{A}=A(t)cos{2π(f_{Lo1}−Δf₁)t+φ_{A}(t)} (1)

S_{B}=B(t)cos{2π(f_{LO1}+Δf₁)t+φ_{B}(t)} (2)

S_{C}=C(t)cos{2π(f_{LO2}−Δf₂)t+φ_{C}(t)} (3)

S_{D}=D(t)cos{2π(f_{LO2}+Δf₂)t+φ_{D}(t)} (4)

In this example, it is assumed for the sake of explanation that f_{LO1}<f_{LO2} and Δf₁<f₂ hold.

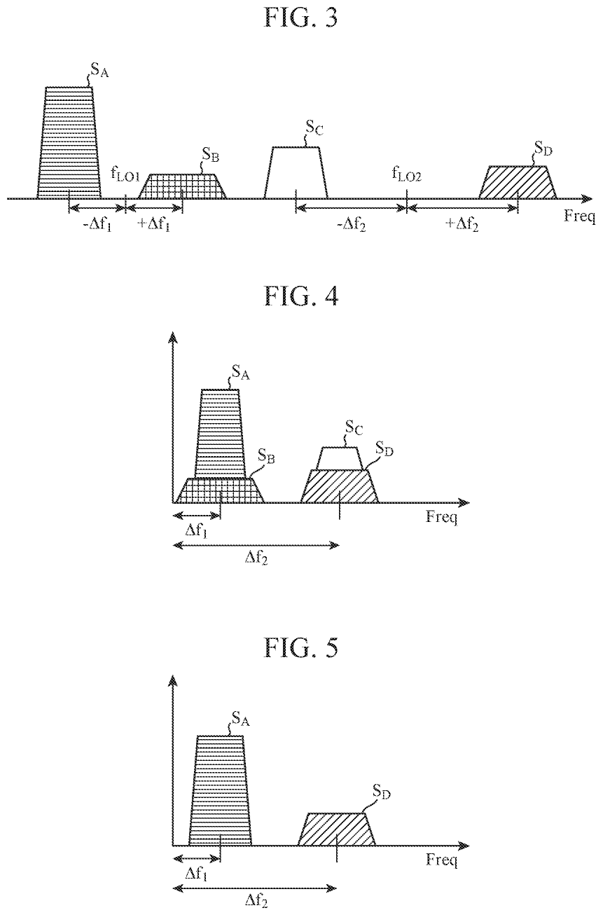

FIG. 3 is a diagram illustrating output signals of the amplifier 3. The power distributor 41 of the frequency converting unit 4 distributes the output signal of the amplifier 3 and outputs the distributed signals separately to the first mixer 42 and the second mixer 43. Meanwhile, the signal source 44 generates local signals to be used by each of the first mixer 42 and the second mixer 43.

Signal source 44 outputs, to first mixer 42, a signal expressed by the following equation:

S_{1,LO}=cos(2πf_{LO1}t+θ_{1_LO1})+cos(2πf_{LO2}t+θ_{1_LO2}) (5),

whereas a signal expressed by the following equation is output to the second mixer 43.

S_{2_LO}=cos(2πf_{LO1}t+θ_{2_LO1})+cos(2πf_{LO2}t+θ_{2_LO2}) (6)

It is only required that θ_{1_LO1}, θ_{1_LO2}, θ_{2_LO1}, and θ_{2_LO2} satisfy the following relational equations:

$$\begin{matrix}{θ}_{1 \_ LO 1} , {θ}_{1 \_ LO 2} , {θ}_{2 \_ LO 1} , \\ {θ}_{2 \_ LO 2} \vert {θ}_{1 \_ LO 1} - {θ}_{2 \_ LO 1} \vert = \frac{π}{2} + 2 n π & ( 7 ) \\ \vert {θ}_{1 \_ LO 2} - {θ}_{2 \_ LO 2} \vert = \frac{π}{2} + 2 n π & ( 8 )\end{matrix}$$

Where, n in equation (7) and equation (8) is an integer.

In this example, for convenience of explanation it is assumed that,

$${θ}_{1 \_ LO 1} = 0 , {θ}_{1 \_ LO 2} = - \frac{π}{2} , {θ}_{2 \_ LO 1} = \frac{π}{2} , {θ}_{2 LO 2} = 0$$

Here, the first term cos(2πf_{LO1}t+θ_{1_LO1}) in equation (5) is defined as a first local signal (hereinafter referred to as a first LO signal) output from the signal source 44, and the second term cos(2πf_{LO2}t+θ_{1_LO2}) is defined as a second local signal (hereinafter referred to as a second LO signal). The first term cos(2πf_{LO1}t+θ_{2_LO1}) of equation (6) is defined as a third local signal (hereinafter referred to as a third LO signal) from the signal source 44, and the second term (2πf_{LO2}t+θ_{2_LO2}) is defined as a fourth local signal (hereinafter referred to as a fourth LO signal). As is clear from the fact that the first LO signal and the third LO signal both include 2πf_{LO1}t, the two have the same frequency. Moreover, as is clear from the fact that the second LO signal and the fourth LO signal both include 2πf_{LO2}t, the two have the same frequency. Meanwhile, the first LO signal includes 2πf_{LO1}t, whereas the second LO signal includes 2πf_{LO2}t, and thus the two have different frequencies. The first LO signal and the third LO signal also have different phases as illustrated in equation (7), and the second LO signal and the fourth LO signal have different phases as illustrated in equation (8).

The first mixer 42 performs frequency conversion by multiplying the output signal of the power distributor 41 and the output signal of the signal source 44 expressed by equation (5). Since the first band pass filter 45 passes only output signals of the first mixer 42 having specific frequencies, an output signal S_{_BPF} of the first band pass filter 45 is expressed by:

S_{1_BPF}=S_{1_A}+S_{1_B}+S_{1_C}+S_{1_D} (9)

Here, the following equations hold.

$$\begin{matrix}{S}_{1 \_ A} = A ( t ) cos ( 2 π Δ {f}_{1} t - {ϕ}_{A} ( t ) ) & ( 10 ) \\ {S}_{1 \_ B} = B ( t ) cos ( 2 π Δ {f}_{1} t + {ϕ}_{B} ( t ) ) & ( 11 ) \\ {S}_{1 \_ C} = C ( t ) cos ( 2 π Δ {f}_{2} t - {ϕ}_{C} ( t ) - \frac{π}{2} ) & ( 12 ) \\ {S}_{1 \_ D} = D ( t ) cos ( 2 π Δ {f}_{2} t - {ϕ}_{D} ( t ) + \frac{π}{2} ) & ( 13 )\end{matrix}$$

FIG. 4 is a diagram illustrating output signals of the first band pass filter 45.

The output signals of the first band pass filter 45 are input to the first AD converter 47.

The second mixer 43 performs frequency conversion by multiplying the output signal of the power distributor 41 and the output signal of the signal source 44 expressed by equation (6). Since the second band pass filter 46 passes only output signals of the second mixer 43 having specific frequencies, an output signal S_{2_BPF} of the second band pass filter 46 is expressed by:

S_{2_BPF}=S_{2_A}+S_{2_B}+S_{2_C}+_{2_D} (14)

Here, the following equations hold.

$$\begin{matrix}{S}_{2 \_ A} = A ( t ) cos ( 2 π Δ {f}_{1} t - {ϕ}_{A} ( t ) - \frac{π}{2} ) & ( 15 ) \\ {S}_{2 \_ B} = B ( t ) cos ( 2 π Δ {f}_{1} t + {ϕ}_{B} ( t ) + \frac{π}{2} ) & ( 16 ) \\ {S}_{2 \_ C} = C ( t ) cos ( 2 π Δ {f}_{2} t - {ϕ}_{C} ( t ) ) & ( 17 ) \\ {S}_{2 \_ D} = D ( t ) cos ( 2 π Δ {f}_{2} t - {ϕ}_{D} ( t ) ) & ( 18 )\end{matrix}$$

The output signals of the second band pass filter 46 are input to the second AD converter 48.

The first AD converter 47 converts the output signals of the first band pass filter 45 from analog to digital. Here, an output signal S_{1_ADC} of the first AD converter 47 is expressed by:

S_{1_ADC}=S_{1_BPF} (19)

The output signal of the first AD converter 47 is input to the first phase changing unit 51 and the second phase changing unit 52. Here, the speed fₛ at which the first AD converter 47 operates (hereinafter referred to as the sampling frequency) is expressed by:

$${f}_{s} > 2 ( Δ {f}_{2} + \frac{BW}{2} ) , \qquad ( 20 )$$

where BW denotes the frequency bandwidth of the signal S_{C} or the signal S_{D} whichever having a wider frequency bandwidth.

The second AD converter 48 converts the output signals of the second band pass filter 46 from analog to digital. Here, an output signal S_{2_ADC} of the second AD converter 48 is expressed by:

S_{2_ADC}=S_{2_BPF} (21)

The output signal of the second AD converter 48 is input to the first phase changing unit 51 and the second phase changing unit 52. Here, the sampling frequency of the second AD converter 48 is the same as the sampling frequency fₛ of the first AD converter 47.

The second 90° phase shifter 521 in the second phase changing unit 52 delays the phase of the output signal of the first AD converter 47 by 90°. An output signal S_{2_90} of the second 90° phase shifter 521 is expressed by:

S_{2_90}=S_{2_90_A}+S_{2_90_B}+S_{2_90_C}+S_{2_90_D} (22)

Here, the following equations hold.

$$\begin{matrix}{S}_{2 \_ 90 \_ A} = A ( t ) cos ( 2 π Δ {f}_{1} t - {ϕ}_{A} ( t ) + \frac{π}{2} ) & ( 23 ) \\ {S}_{2 \_ 90 \_ B} = B ( t ) cos ( 2 π Δ {f}_{1} t + {ϕ}_{B} ( t ) + \frac{π}{2} ) & ( 24 ) \\ {S}_{2 \_ 90 \_ C} = C ( t ) cos ( 2 π Δ {f}_{2} t - {ϕ}_{C} ( t ) ) & ( 25 ) \\ {S}_{2 \_ 90 \_ D} = D ( t ) cos ( 2 π Δ {f}_{2} t + {ϕ}_{D} ( t ) + π ) & ( 26 )\end{matrix}$$

The output signal of the second 90° phase shifter 521 is input to the second adder 54.

The first 90° phase shifter 511 in the first phase changing unit 51 delays the phase of the output signal of the second AD converter 48 by 90°. An output signal S_{1_90} of the first 90° phase shifter 511 is expressed by:

S_{1_90}=S_{1_90_A}+S_{1_90_B}+S_{1_90_C}+S_{1_90_D} (27)

Here, the following equations hold.

$$\begin{matrix}{S}_{1 \_ 90 \_ A} = A ( t ) cos ( 2 π Δ {f}_{1} t - {ϕ}_{A} ( t ) ) & ( 28 ) \\ {S}_{1 \_ 90 \_ B} = B ( t ) cos ( 2 π Δ {f}_{1} t + {ϕ}_{B} ( t ) + π ) & ( 29 ) \\ {S}_{1 \_ 90 \_ C} = C ( t ) cos ( 2 π Δ {f}_{2} t - {ϕ}_{C} ( t ) + \frac{π}{2} ) & ( 30 ) \\ {S}_{1 \_ 90 \_ D} = D ( t ) cos ( 2 π Δ {f}_{2} t + {ϕ}_{D} ( t ) + \frac{π}{2} ) & ( 31 )\end{matrix}$$

The output signal of the first 90° phase shifter 511 is input to the first adder 53.

Here, as is clear from the comparison between equations (10) and (28), first radio signals S_{A} output from the first output terminal 51a and the second output terminal 51b in the first phase changing unit 51 are in-phase. That is, the terms “φ_{A}(t)” including the phase in the equations are the same. Similarly, second radio signals S_{D} output from the first output terminal 51a and the second output terminal 51b in the first phase changing unit 51 are in-phase since the terms including the phase are both “φ_{D}(t)+π/2” as is apparent from the comparison between the equations (13) and (31). Meanwhile, third radio signals S_{B} output from the first output terminal 51a and the second output terminal 51b have reversed phases since the terms including the phase are “φ_{B}(t)” and “φ_{B}(t)+π,” and the phases are shifted by it as is clear from the comparison between equations (11) and (29) Likewise, fourth radio signals S_{C} outputted from the first output terminal 51a and the second output terminal 51b have reversed phases since the terms including the phase are “φ_{C}(t)−πt/2” and “φ_{C}(t)+π/2,” and the phases are shifted by it as is clear from the comparison between equations (12) and (30).

Moreover, as is apparent from the comparison between equations (15) and (23), first radio signals S_{A} output from the first output terminal 52a and the second output terminal 52b in the second phase changing unit 52 have reversed phases since the phases are shifted by it in the terms including phases as “φ_{A}(t)−π/2” and “φ_{A}(t)+π/2” in the equations. Next, as is apparent from the comparison between equations (18) and (26), the second radio signals S_{D} have reversed phases since the phases are shifted by it in the terms including the phase as “φ_{D}(t)” and “φ_{D}(t)+π” in the equations. Meanwhile, as is apparent from the comparison between equations (16) and (24), third radio signals S_{B} are in-phase since the terms including the phase in the equations are the same both being “φ_{B}(t)+π/2.” Moreover, as is apparent from the comparison between equations (17) and (25), fourth radio signals Sc are in-phase since the terms including the phase in the equations are the same both being “φ_{C}(t).”

The output signals from the first phase changing unit 51 are added by the first adder 53, and the output signals from the second phase changing unit 52 are added by the second adder 54, thereby separating the first to fourth radio signals S_{A} to S_{C}.

The first adder 53 adds the output signal S_{1_ADC} from the first output terminal 51a of the first phase changing unit 51 and the output signal S_{1_90} of the first 90° phase shifter 511.

An output signal S_{1_ADD} of the first adder 53 is expressed by:

S_{1_ADD}=S_{ADD_A}S_{ADD_D} (32)

Here, the following equations hold.

$$\begin{matrix}{S}_{ADD\_A} = 2 A ( t ) cos ( 2 π Δ {f}_{1} t - {ϕ}_{A} ( t ) ) & ( 33 ) \\ {S}_{ADD\_D} = 2 D ( t ) cos ( 2 π Δ {f}_{2} t + {ϕ}_{D} ( t ) + \frac{π}{2} ) & ( 34 )\end{matrix}$$

The output signals of the first adder 53 are input to each of the first low pass filter 55 and the first high pass filter 56. FIG. 5 is an explanatory diagram illustrating output signals of the first adder 53.

The second adder 54 adds the output signal S_{2_ADC} of the second AD converter 48 and the output signal S_{2_90} of the second 90° phase shifter 521.

The output signal S_{2_ADD} of the second adder 54 is expressed by:

S_{2_ADD}=S_{ADD_B}+S_{ADD_C} (35)

Here, the following equations hold.

$$\begin{matrix}{S}_{ADD\_B} = 2 B ( t ) cos ( 2 π Δ {f}_{1} t + {ϕ}_{B} ( t ) + \frac{π}{2} ) & ( 36 ) \\ {S}_{ADD\_DC} = 2 C ( t ) cos ( 2 π Δ {f}_{2} t - {ϕ}_{C} ( t ) ) & ( 37 )\end{matrix}$$

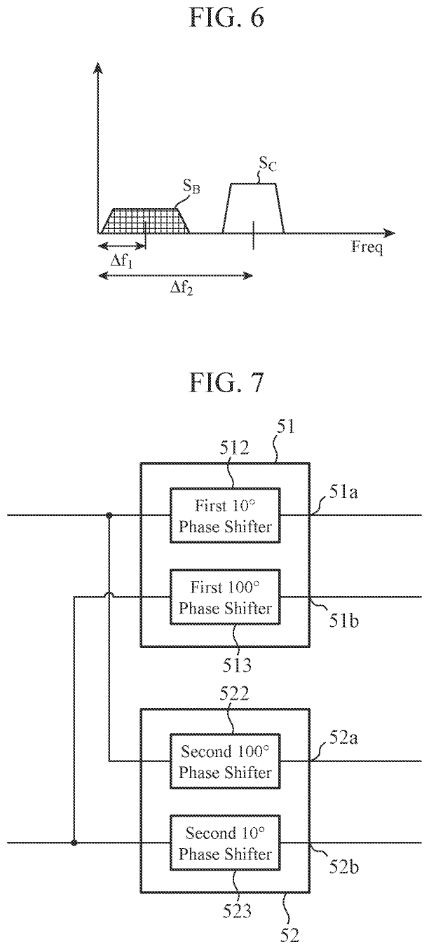

The output signals of the second adder 54 are input to each of the second low pass filter 57 and the second high pass filter 58. FIG. 6 is an explanatory diagram illustrating output signals of the second adder 54.

Since only a signal having a low frequency in the output signals of the first adder 53 passes the first low pass filter 55, the output signal S_{1_LPF} of the first low pass filter 55 is expressed by:

$$\begin{matrix}{S}_{1 \_ LPF} = 2 A ( t ) cos ( 2 πΔ {f}_{1} t - {ϕ}_{A} ( t ) ) \\ = 2 A ( t ) cos ( - 2 πΔ {f}_{1} t + {ϕ}_{A} ( t ) ) .\end{matrix} \qquad ( 38 )$$

The output signal of the first low pass filter 55 is input to the demodulator 6 and demodulated by the demodulator 6.

Meanwhile, since only a signal having a high frequency in the output signals of the first adder 53 passes the first high pass filter 56, the output signal S_{1 HPF} of the first high pass filter 56 is expressed by:

$${S}_{1 \_HPF} = 2 D ( t ) cos ( 2 π Δ {f}_{2} t + {ϕ}_{D} ( t ) + \frac{π}{2} ) . \qquad ( 39 )$$

The output signal of the first high pass filter 56 is input to the demodulator 6 and demodulated by the demodulator 6.

Since only a signal having a low frequency in the output signals of the second adder 54 passes the second low pass filter 57, the output signal S_{2_LPF} of the second low pass filter 57 is expressed by:

$${S}_{2 \_LPF} = 2 B ( t ) cos ( 2 π Δ {f}_{1} t + {ϕ}_{B} ( t ) + \frac{π}{2} ) . \qquad ( 40 )$$

The output signal of the second low pass filter 57 is input to the demodulator 6 and demodulated by the demodulator 6.

Meanwhile, since only a signal having a high frequency in the output signals of the second adder 54 passes the second high pass filter 58, the output signal S_{2_HPF} of the second high pass filter 58 is expressed by:

$$\begin{matrix}{S}_{2 \_ HPF} = 2 C ( t ) cos ( 2 πΔ {f}_{2} t - {ϕ}_{C} ( t ) ) \\ = 2 C ( t ) cos ( - 2 πΔ {f}_{2} t + {ϕ}_{C} ( t ) ) .\end{matrix} \qquad ( 41 )$$

The output signal of the second high pass filter 58 is input to the demodulator 6 and demodulated by the demodulator 6.

In this manner, in the present embodiment, the number of signal sources for mixers necessary for reception is minimized even in the case where signals of four radio frequency bands are received, and even in the case where the signals after frequency conversion overlap with each other, the signals can be separated by performing signal processing, thereby enabling simultaneously receiving a plurality of radio signals while increase of the circuit size and increase in the power consumption are suppressed.

Note that, in the above example, although the explanation has been given under the condition of f_{LO1}<f_{LO2} and Δf₁<Δf₂, the same effect can be obtained also under the conditions of:

f_{LO1}>f_{LO2} and Δf₁<Δf₂,

f_{LO1}<f_{LO2} and Δf₁>Δf₂, or

f_{LO1}>f_{LO2} and Δf₁>Δf₂.

Moreover, the first 90° phase shifter 511 and the second 90° phase shifter 521 provide the same effect also in the case of advancing the phase by 90°.

In the above example, the first phase changing unit 51 and the second phase changing unit 52 includes the first 90° phase shifter 511 and the second 90° phase shifter 521, respectively; however, it is only required that the phase difference between the signals output from the first output terminals 51a and 52a and the second output terminals 51b and 52b be 90°. Thus, for example 10° phase shifters and 100° phase shifters may be used in the configuration as illustrated in FIG. 7. In FIG. 7, a first phase changing unit 51 includes a first 10° phase shifter 512 and a first 100° phase shifter 513. That is, the first 10° phase shifter 512 is provided to the portion connecting directly from the input side to the first output terminal 51a in the configuration of FIG. 2, and the first 100° phase shifter 513 replaces the first 90° phase shifter 511. Likewise, the first 100° phase shifter 522 replaces the second 90° phase shifter 521 in the configuration of FIG. 2, and the first 10° phase shifter 523 is provided between the input side and the second output terminal 52b.

Note that the angle of changing the phase is not necessary 90° as long as the in-phase/reversed phase relationship of outputs of the first phase changing unit 51 and the second phase changing unit 52 satisfies the signal separation condition in the posterior adders.

Meanwhile, replacing the first band pass filter 45 and the second band pass filter 46 with low pass filters, band limiting filters, or the like also results in the same effect.

In addition, replacing the first low pass filter 55, the first high pass filter 56, the second low pass filter 57, and the second high pass filter 58 with band pass filters, band limiting filters, or the like also results in the same effect.

Furthermore, although the case where the number of radio signals to be received is four has been described in the present embodiment, the present embodiment becomes also applicable, like in the case of four radio signals, to a case where the number of radio signals to be received is three by setting one of the four radio signals as a virtual signal.

As described above, the receiver of the first embodiment includes: the signal source for generating first to fourth local signals; the first mixer for performing frequency conversion on four radio signals having different frequencies using the first and second local signals; the second mixer for performing frequency conversion on the four radio signals having different frequencies using the third and fourth local signals; the first phase changing unit for receiving output signals of the first mixer and output signals of the second mixer as input signals and outputting signals obtained by changing phases of the input signals from the first and second output terminals thereof; the second phase changing unit for receiving output signals of the first mixer and output signals of the second mixer as input signals and outputting signals obtained by changing phases of the input signals from the first and second output terminals thereof; the first adder for adding the signals of the first and second output terminals of the first phase changing unit; and the second adder for adding the signals of the first and second output terminals of the second phase changing unit, in which the first local signal and the third local signal have a same frequency but are out of phase, the second local signal and the fourth local signal have a same frequency but are out of phase, and the first local signal and the second local signal have different frequencies. This makes it possible to minimize the number of signal sources that are necessary and to suppress increase of the circuit size and increase in the power consumption while simultaneous reception of a plurality of radio signals is enabled.

Also, according to the receiver of the first embodiment, the first phase changing unit changes the phases of the input signals in such a manner that: a phase of the first radio signal output from the first output terminal of the first phase changing unit and a phase of the first radio signal output from the second output terminal of the first phase changing unit are in-phase with each other; a phase of the second radio signal output from the first output terminal of the first phase changing unit and a phase of the second radio signal output from the second output terminal of the first phase changing unit are in-phase with each other; a phase of the third radio signal output from the first output terminal of the first phase changing unit and a phase of the third radio signal output from the second output terminal of the first phase changing unit are reversed; and a phase of the fourth radio signal output from the first output terminal of the first phase changing unit and a phase of the fourth radio signal output from the second output terminal of the first phase changing unit are reversed, and the second phase changing unit changes the phases of the input signals in such a manner that: a phase of the first radio signal output from the first output terminal of the second phase changing unit and a phase of the first radio signal output from the second output terminal of the second phase changing unit are reversed; a phase of the second radio signal output from the first output terminal of the second phase changing unit and a phase of the second radio signal output from the second output terminal of the second phase changing unit are reversed; a phase of the third radio signal output from the first output terminal of the second phase changing unit and a phase of the third radio signal output from the second output terminal of the second phase changing unit are in-phase with each other; and a phase of the fourth radio signal output from the first output terminal of the second phase changing unit and a phase of the fourth radio signal output from the second output terminal of the second phase changing unit are in-phase with each other. Therefore, separation of the plurality of signals can be reliably performed.

Moreover, according to the receiver of the first embodiment, the phase difference between the first local signal and the third local signal is 90° or −90°, and the phase difference between the second local signal and the fourth local signal is 90° or −90°, and thus separation of a plurality of signals can be reliably performed.

Since the first mixer and the second mixer perform frequency conversion on three radio signals instead of four radio signals, and thus the present embodiment is also applicable to a case of three radio signals.

Furthermore, according to the receiver of the first embodiment, the first filter and the first analog-to-digital converter are included between the output terminal of the first mixer and a connection point of the input terminal of the first phase changing unit and the input terminal of the second phase changing unit, and the second filter and the second analog-to-digital converter are included between the output terminal of the second mixer and a connection point of the input terminal of the first phase changing unit and the input terminal of the second phase changing unit. Therefore, it is possible to synthesize signals accurately in the posterior stage.

### Second Embodiment

A receiver according to a second embodiment is different from the receiver of the first embodiment in that AD converters in a frequency converting unit operate by under-sampling. The illustrative configuration is similar to that of the first embodiment illustrated in FIGS. 1 and 2, and thus description will be given with reference to FIGS. 1 and 2.

In the first embodiment, the first AD converter 47 and the second AD converter 48 are operated using the sampling frequency expressed by equation (20). Here, depending on radio signals received, there are cases where Δf₁<<Δf₂ holds, and the sampling frequency becomes higher. When the sampling frequency becomes higher, the power consumption of the first AD converter 47 and the second AD converter 48 increases. Therefore, in the second embodiment, increase in the power consumption of the first AD converter 47 and the second AD converter 48 is suppressed by under-sampling, and signals of four frequency bands are simultaneously received.

In the second embodiment, an under-sampling technique is used in which the first AD converter 47 and the second AD converter 48 are operated at a sampling frequency less than or equal to twice the frequency of radio signals to be received, and frequencies of the signals are converted to frequencies in the range of 0 Hz to (1/2)fₛ (hereinafter referred to as a first Nyquist zone) by using aliasing, and at the same time analog signals are converted into digital signals.

Hereinafter, the operation of the second embodiment will be described focusing on different parts from the first embodiment.

The output signal of the first band pass filter 45 is expressed by equation (9) like in the first embodiment. Here, it is assumed that Δf₁<<Δf₂ holds. A signal having a center frequency of Δf₁ is denoted as signal S_{A}S_{B}, and a signal having a center frequency of Δf₂ is denoted as signal S_{C}S_{D}.

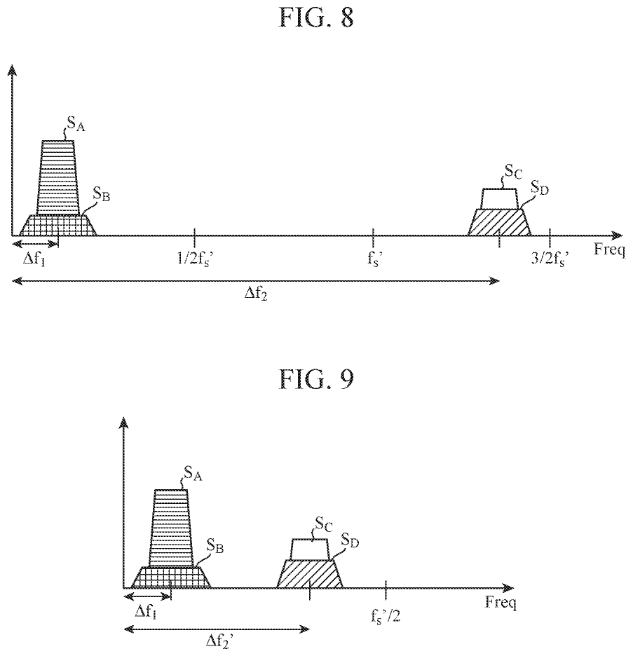

The first AD converter 47 under-samples the signal S_{A}S_{B} and the signal S_{C}S_{D} output from a first band pass filter 45 at a sampling frequency of fₛ′ and converts the analog signals to digital signals. Here, it is assumed that the signal S_{A}S_{B} before input to the first AD converter 47 is in the first Nyquist zone and that the signal S_{C}S_{D} is in the range between fₛ′ and (3/2)fₛ′. FIG. 8 illustrates input signals of the first AD converter 47. Note that used is such a sampling frequency fₛ′ that prevents signal components of the signal S_{A}S_{B} and the signal S_{C}S_{D} from overlapping with each other after under-sampling.

A center frequency Δf₂′ of the signal S_{C}S_{D} after under-sampling is expressed by:

Δf′₂=3/2f′ₛ−Δf₂

Replacing Δf₂ in equations (12) and (13) with Δf₂′ results in same equations as the equation representing output signals of the first AD converter 47 expressed by equations (12) and (13). FIG. 9 illustrates the output signals of the first AD converter 47.

The second AD converter 48 under-samples output signals of a second band pass filter 46 at the same sampling frequency fₛ′ as that of the first AD converter 47.

The operation other than that of the first AD converter 47 and the second AD converter 48 is the same as that of the first embodiment, and thus description thereof is omitted.

Note that, the center frequency Δf₂′ of the signal S_{C}S_{D} after under-sampling and the center frequency Afi of the signal S_{A}S_{B} are in a relationship of Δf₂′>Δf₁ in the description of the present embodiment; however, the same effect can be obtained even when a sampling frequency fₛ′ that results in a relationship of Δf₂′<Δf₁ is selected as long as signal components of the signal S_{A}S_{B} and the signal S_{C}S_{D} do not overlap each other.

Furthermore, the case where only the signal S_{C}S_{D} is under-sampled has been described in the description of the present embodiment; however, both the signal S_{A}S_{B} and the signal S_{C}S_{D} may be under-sampled as long as signal components of the signal S_{A}S_{B} and the signal S_{C}S_{D} after under-sampling do not overlap each other.

Furthermore, the number of times of aliasing of the signal S_{A}S_{B} and the number of times of aliasing of the signal S_{C}S_{D} are not necessarily the same, and there is no limit on the number of times of aliasing.

As described above, according to the receiver of the second embodiment, the first filter outputs two signals having different center frequencies and allows the frequency of at least one of the two signals to be higher than a half of a sampling frequency of the first analog-to-digital converter and to prevent components of the two signals from overlapping with each other after under-sampling is performed at the sampling frequency, and a sampling frequency of the second analog-to-digital converter is the same as the sampling frequency of the first analog-to-digital converter. Therefore, an increase in the power consumption can be further suppressed in addition to the effects of the first embodiment.

Note that the present invention may include a flexible combination of the respective embodiments, a modification of any component of the respective embodiments, or an omission of any component in the respective embodiments within the scope of the present invention.

### INDUSTRIAL APPLICABILITY

As described above, a receiver according to the present invention relates to a configuration for simultaneously receiving and separating radio signals of a plurality of frequency bands, and is suitable for use in a multi-channel receiver for simultaneously receiving a plurality of radio signals.

### REFERENCE SIGNS LIST

1: Antenna, 2: Filter, 3: Amplifier, 4: Frequency converting unit, 5: Signal separating unit, 6: Demodulator, 41: Power distributor, 42: First mixer, 43: Second mixer, 44: Signal source, 45: First band pass filter, 46: Second band pass filter, 47: First AD converter, 48: Second AD converter, 51: First phase changing unit, 51a: First output terminal, 51b: Second output terminal, 52: Second phase changing unit, 52a: First output terminal, 52b: Second output terminal 52b, 53: First adder, 54: Second adder, 55, 57: First low pass filter, 56, 58: First high pass filter, 511: First 90° phase shifter, 512: First 10° phase shifter, 513: First 100° phase shifter, 521: Second 90° phase shifter, 522: First 100° phase shifter, 523: First 10° phase shifter.

1. A receiver, comprising:
a signal source to generate first to fourth local signals;
a first mixer to perform frequency conversion on four radio signals having different frequencies using the first and second local signals;
a second mixer to perform frequency conversion on the four radio signals having different frequencies using the third and fourth local signals;
a first phase changer to receive output signals of the first mixer and output signals of the second mixer as input signals and outputting signals obtained by changing phases of the input signals from first and second output terminals thereof;
a second phase changer to receive output signals of the first mixer and output signals of the second mixer as input signals and outputting signals obtained by changing phases of the input signals from first and second output terminals thereof;
a first adder to add the signals of the first and second output terminals of the first phase changer; and
a second adder to add the signals of the first and second output terminals of the second phase changer,
wherein the first local signal and the third local signal have a same frequency but are out of phase, the second local signal and the fourth local signal have a same frequency but are out of phase, and the first local signal and the second local signal have different frequencies.

2. The receiver according to claim 1,
wherein the first phase changer changes the phases of the input signals in such a manner that:
a phase of the first radio signal output from the first output terminal of the first phase changer and a phase of the first radio signal output from the second output terminal of the first phase changer are in-phase with each other;
a phase of the second radio signal output from the first output terminal of the first phase changer and a phase of the second radio signal output from the second output terminal of the first phase changer are in-phase with each other;
a phase of the third radio signal output from the first output terminal of the first phase changer and a phase of the third radio signal output from the second output terminal of the first phase changer are reversed; and
a phase of the fourth radio signal output from the first output terminal of the first phase changer and a phase of the fourth radio signal output from the second output terminal of the first phase changer are reversed, and
the second phase changer changes the phases of the input signals in such a manner that:
a phase of the first radio signal output from the first output terminal of the second phase changer and a phase of the first radio signal output from the second output terminal of the second phase changer are reversed;
a phase of the second radio signal output from the first output terminal of the second changer and a phase of the second radio signal output from the second output terminal of the second phase changer are reversed;
a phase of the third radio signal output from the first output terminal of the second phase changer and a phase of the third radio signal output from the second output terminal of the second phase changer are in-phase with each other; and
a phase of the fourth radio signal output from the first output terminal of the second phase changing unitchanger and a phase of the fourth radio signal output from the second output terminal of the second phase changer are in-phase with each other.

3. The receiver according to claim 1, wherein a phase difference between the first local signal and the third local signal is 90° or −90°, and a phase difference between the second local signal and the fourth local signal is 90° or −90°.

4. The receiver according to claim 1, further comprising:
a first filter and a first analog-to-digital converter disposed between an output terminal of the first mixer and a connection point of an input terminal of the first phase changer and an input terminal of the second phase changer; and
a second filter and a second analog-to-digital converter disposed between an output terminal of the second mixer and a connection point of an input terminal of the first phase changer and an input terminal of the second phase changer.

5. The receiver according to claim 4,
wherein the first filter outputs two signals having different center frequencies and allows a frequency of at least one of the two signals to be higher than a half of a sampling frequency of the first analog-to-digital converter and to prevent components of the two signals from overlapping with each other after under-sampling is performed at the sampling frequency, and
a sampling frequency of the second analog-to-digital converter is same as the sampling frequency of the first analog-to-digital converter.

6. The receiver according to claim 1, wherein the first mixer and the second mixer perform frequency conversion on three radio signals instead of the four radio signals.
